(19) United States
(12) Patent Application Publication
(10) Pub. No.: US 2010/0045055 A1
(43) Pub. Date: Feb. 25, 2010

(54) Striker Bar Assembly With Handle

(76) Inventor: Edward Taglianetti, Staten Island, NY (US)

Correspondence Address: HOFFMANN & BARON, LLP, 6900 JERICHO TURNPIKE, SYOSSET, NY, 11791, US

(21) Appl. No.: 12/607,609

(22) Filed: Oct. 28, 2009

Related U.S. Application Data
(63) Continuation of application No. 11/699,119, filed on Jan. 29, 2007, now abandoned.
(60) Provisional application No. 60/763,561, filed on Jan. 31, 2006.

(51) Int. Cl. E05B 15/02

(52) U.S. Cl. 292/341.15

(57) ABSTRACT

A striker bar assembly for use with a gate latch assembly includes a handle for ease of opening and closing the gate. The striker bar assembly includes a striker bar which cooperates with a latching tongue on the gate latch assembly to selectively maintain a gate in a closed position. The handle on the striker bar assembly is integrally formed therewith and extends outward toward the operator for easy grasping.

### CROSS-REFERENCE TO RELATED APPLICATIONS

This application is a continuation of U.S. patent application Ser. No. 11/699,119 filed on Jan. 29, 2007. This application also claims the benefit of U.S. Provisional Patent Application Ser. No. 60/763,561 filed on Jan. 31, 2006.

### BACKGROUND OF THE INVENTION

1. Field of the Invention

The present invention relates generally to the field of latching mechanisms, and more particularly, to striker designs for use with latching mechanisms for fence gates and the like.

2. Description of the Related Art

Gate latches provide a simple method for securing fence gates from unwanted opening while allowing the gate to be opened, closed and locked at will with a minimum amount of effort.

A typical gate latch is comprised of a main body having a latch mechanism on one gate post and a striker bar which aligns with the latch mechanism on the other gate post. In the closed position, the striker bar is held in place by the latch mechanism, which, when released, allows the gate to be opened.

Many currently available gate latches utilize a fixed main body having a latch that uses the force of gravity to pull the latch plate down on a protruding striker bar. Alternatively, the latch mechanism may include a lock to prevent opening of the gate without a key. Thus, the latch may be opened either normally by a user or through the operation of the lock to release the striker bar to open the gate. A typical gate latch including a lock is illustrated in FIG. 1.

### SUMMARY OF THE INVENTION

It is an object of the invention to provide a striker bar assembly which is easier to grasp for opening and closing a gate or the like.

It is a further object of the invention to provide a striker bar assembly which includes a handle to assist in grasping the gate for operation.

Thus, in accordance with the invention, a novel striker bar assembly is provided which can be used with a wide variety of latch body assemblies. In particular, the striker bar assembly includes a mounting portion for securing the striker bar assembly to a gate post, a handle portion which preferably includes an opening to receive an operator's hand, and a striker bar extending outwardly from the striker bar assembly to cooperate with a latching tongue of a gate latch assembly mounted on an opposing gate post. In a most preferred embodiment, the mounting portion and handle are an integrally formed, one-piece construction including a striker bar mounting opening therein. A separately formed striker bar is secured in the mounting opening to complete the striker bar assembly.

### BRIEF DESCRIPTION OF THE DRAWINGS

FIG. 1 is a perspective view of a commonly available gate latch assembly.

FIG. 2 is a perspective view of a striker bar assembly including a handle formed in accordance with the present invention.

FIG. 3 is an alternative perspective view of the striker bar assembly as shown in FIG. 2.

FIG. 4 is a front perspective view of an alternative striker bar assembly formed in accordance with the present invention.

FIG. 5 is a side view of the striker assembly as shown in FIG. 4.

FIG. 6 is a perspective view of a gate latch assembly formed in accordance with the present invention.

### DETAILED DESCRIPTION OF PREFERRED EMBODIMENTS

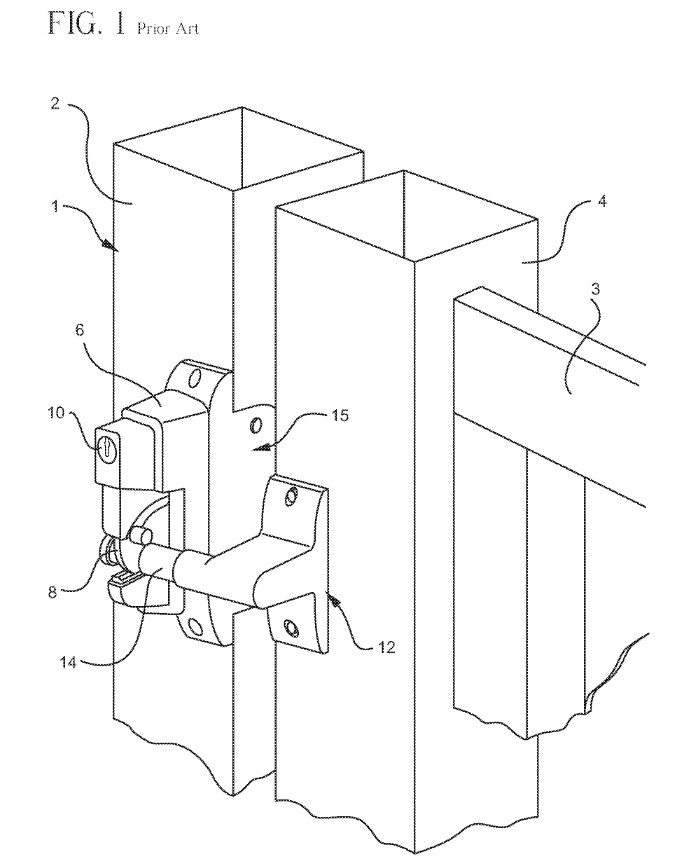

Referring to FIG. 1, a commonly available gate latch assembly 15 is shown mounted to a fence. The fence includes a stationary portion 1 and a hinged gate 3. The stationary portion 1 includes a fence post 2 and the gate includes a gate post 4. The gate latch assembly 15 comprises a main body 6, including a latch mechanism including a pivotally movable latching tongue 8 and is secured to the stationary fence post 2. The latch mechanism may include a lock 10 to selectively lock the latch latching tongue 8 in a closed position. The gate latch assembly also includes a striker bar assembly 12 secured to the gate post 4. The striker bar assembly 12 includes a body for holding the striker bar 14 which engages with the latching tongue 8 to maintain the gate in a closed position. The latching tongue may be manually operated to release the striker bar, allowing the gate to be opened. As is readily apparent, it can oftentimes be difficult to grasp the striker bar assembly 12. The striker bar assembly 12 is closely mounted to both the gate post 4 as well as the main body 6 of the gate latch assembly making grasping of the striker bar assembly difficult.

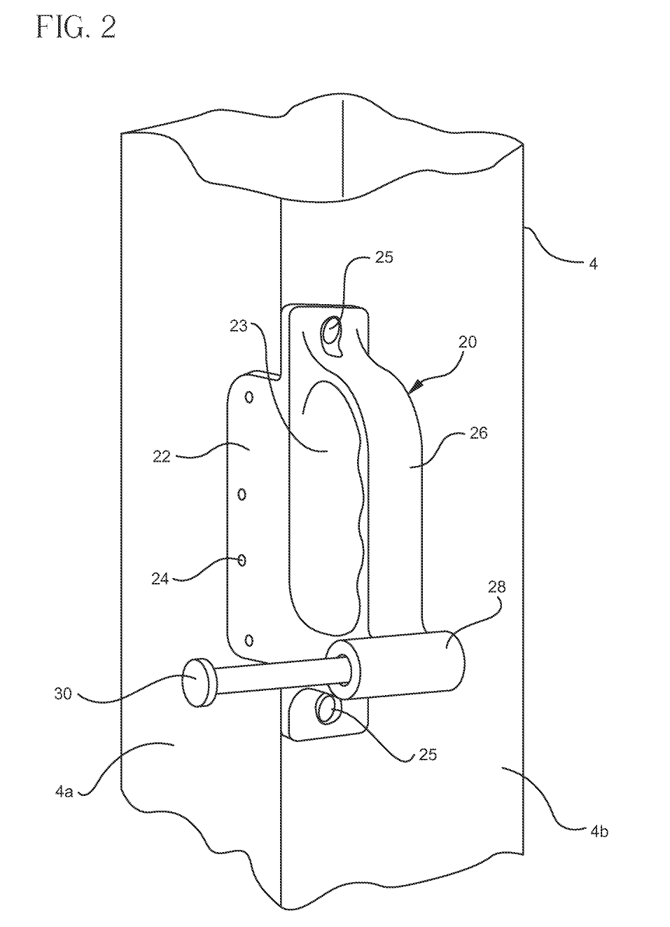

To overcome the disadvantages of the gate latch assembly illustrated in FIG. 1, a novel striker bar assembly formed in accordance with the present invention includes a handle portion. Specifically, as illustrated in FIG. 2, a striker bar assembly 20 of the present invention includes a means for securing the striker bar assembly to a gate post in the form of a mounting plate 22 which extends rearwardly from the striker bar assembly body 23. The mounting plate 22 and back portion of body 33 form an L-shaped bracket to securely fasten the striker bar assembly 20 to the gate post 4. The mounting plate 22 includes a plurality of spaced apart mounting holes to receive fasteners such as screws or the like for securing the striker assembly 20 to a side surface 4a of the gate post 4. While the preferred embodiment discloses an L-shaped bracket as a means for mounting the striker bar assembly to the gate post, the mounting plate may be eliminated and the striker bar assembly may be fastened to the post by fasteners extending through a front surface of the body 23.

The striker bar assembly 20 also includes a handle portion 26 extending outwardly toward the operator for ease of grasping. As will be appreciated by those skilled in the art, the handle portion 26 can be formed in any shape desired, including shapes having openings to receive an operator's hand such as a loop-type handle or a knob-type handle for ease of grasping. In the preferred embodiment as illustrated in FIG. 2, the handle portion 26 is provided in the shape of a semi-circular loop-type handle having an opening through which a user may place their hand. Further mounting holes 25 are provided on the body 23 to receive for fasteners to securely affix the striker bar assembly 20 to a front surface 4b of the gate post 4.

The striker bar assembly body 23 also includes a striker bar mounting means for fixedly holding the striker bar 30. The striker bar mounting means is preferably a boss 28 having an opening therein for receiving a mounting end of the striker bar 30. The boss 28 preferably includes an elongated opening extending completely therethrough so that the striker bar 30 may be securely mounted to extend from either side of the striker bar assembly, depending upon the application. Moreover, the striker bar assembly is designed to be mounted either with the striker bar at a top or bottom position depending upon the application yet still provide the advantages of a grippable handle.

The striker bar assembly 20 of the present invention can be used in conjunction with a variety of main body assemblies mounted to a stationary fence post or the like. The only requirement of the main body assembly is that it have a latch mechanism which can receive and selectively hold the striker bar. Accordingly, the striker bar assembly of the present invention has many applications as will be appreciated by those of ordinary skill in the art.

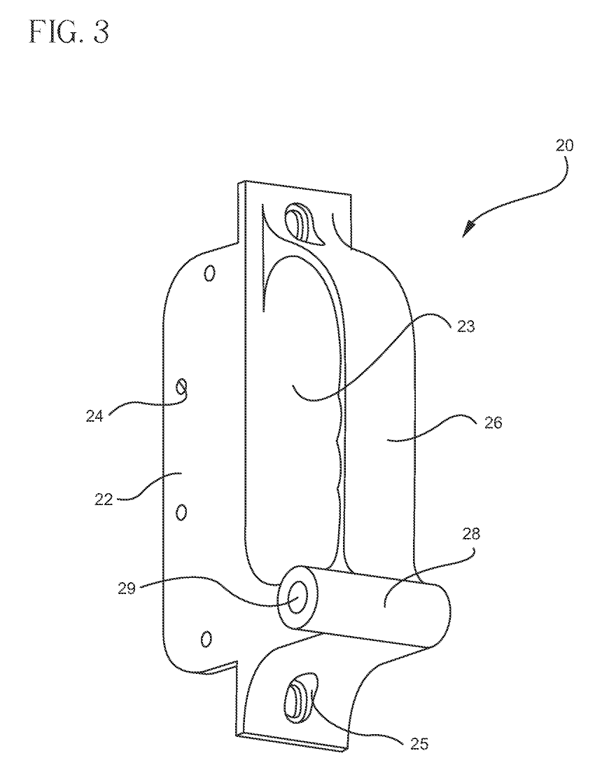

FIG. 3 is an alternative perspective view of the striker bar assembly 20 shown in FIG. 2, with the striker bar removed so that the opening 29 extending completely through boss 28 is visible.

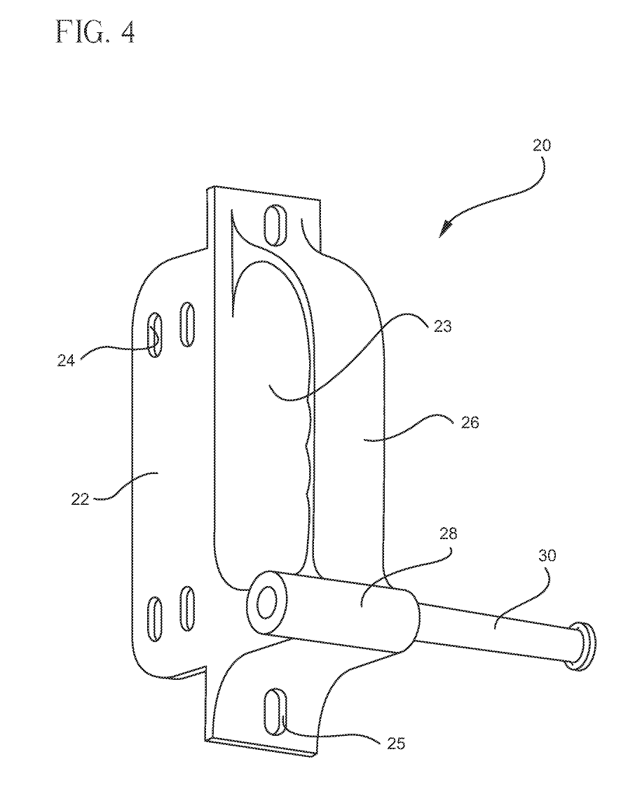

FIG. 4 is a front perspective view of a further alternative embodiment of a striker bar assembly 20 formed in accordance with the present invention. The striker bar assembly is preferably made from high strength plastic and most preferably from a molded polymer, glass fiber reinforced material to provide a sturdy, safe, durable, rust free and visually attractive assembly. Accordingly, the striker bar assembly excluding the striker bar, is a unitary molded component for ease of manufacturing.

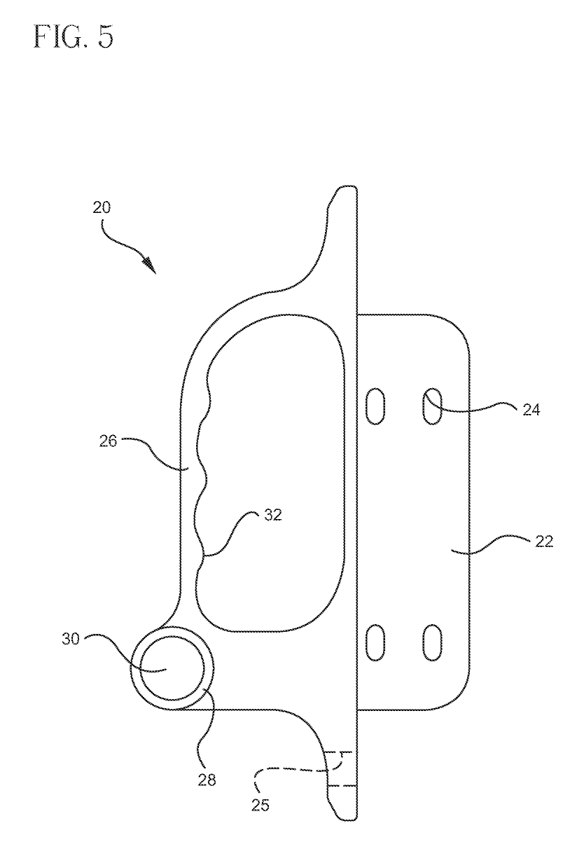

FIG. 5 is a side view of the striker bar assembly 20 shown in FIG. 4. As illustrated in FIG. 5, the handle portion 26 preferably includes finger grip contours 32 to assist in grasping the handle. Also, the mounting holes 24 are preferably elongated to permit minor adjustments for alignment with a gate latch and ease of mounting to the gate post 4.

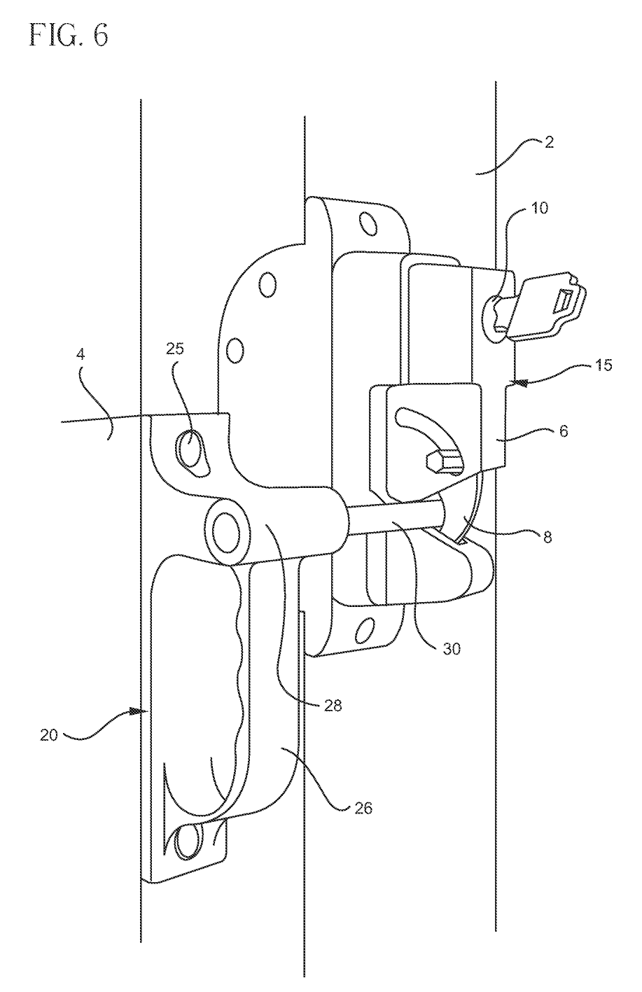

FIG. 6 is a perspective view of a gate latch assembly illustrating the cooperation between the striker bar assembly 20 and the latching tongue 8 of the gate latch assembly 15 to selectively maintain the gate in a closed position. As can be seen, the striker bar assembly including an outwardly extending handle makes grasping the gate much easier to open or close.

Having illustrated and described a preferred embodiment of the invention and certain possible modifications thereto, it should be apparent to those of ordinary skill in the art that the invention may be further modified in arrangement and detail without departing from the scope and spirit of the invention. For example, the gate latch striker bar assembly could be made from a variety of materials including plastic and/or metal provided the function is maintained. Furthermore, the striker bar assembly of the present invention may be adapted to also be used to work on screen doors, doors for sheds, barns, etc. All such modifications are contemplated and fall within the scope of the invention.

What is claimed is:

1. A striker bar assembly for use in cooperation with a latch mechanism comprising:
a body including a mounting means for securing the striker bar assembly to a pivotably movable door, the body including an outwardly extending handle having an aperture, the body further including a boss at a distal end of the body and adjacent to the handle aperture, the boss including a striker bar receiving opening therein; and
a striker bar having a mounting end directly inserted into the striker bar receiving opening to securely mount the striker bar to the boss and wherein the boss is positioned on the body such that the striker bar does not contact the pivotably movable door.

2. A striker bar assembly as defined in claim 1, wherein the mounting means includes a mounting plate having a plurality of openings to receive fastening devices.

3. A striker bar assembly as defined in claim 2, wherein a back surface of the body and the mounting plate form a generally L-shaped bracket.

4. A striker bar assembly as defined in claim 1, wherein the body is in the form of a molded polymer.

5. A striker bar assembly as defined in claim 1, wherein the handle is substantially semi-circular.

6. A striker bar assembly as defined in claim 1, wherein the aperture in the handle includes a contoured surface.

7. A striker bar assembly as defined in claim 1, wherein the striker bar receiving opening in the boss is an elongated opening extending through the entire length thereof.

8. A striker bar assembly as defined in claim 7, wherein the striker bar may be mounted to extend from either side of the elongated opening.

9. In combination:
a gate latch secured to a stationary portion of a fence, the gate latch comprising a housing including a pivotable latching tongue; and
a striker bar assembly secured to a hinged fence gate, the striker bar assembly comprising a body including a mounting means for securing the striker bar assembly to a pivotably movable door, the body further including an integrally formed handle having an aperture; means for mounting a striker bar to the body including a boss having a striker bar receiving opening therein; and a striker bar securely mounted directly in the striker bar receiving opening; wherein the striker bar extends outwardly from the fence gate and the gate latch body to operatively cooperate with the latching tongue to selectively maintain the gate in a closed position.

10. A striker bar assembly as defined in claim 9, wherein the mounting means includes a mounting plate having a plurality of openings to receive fastening devices.

11. A striker bar assembly as defined in claim 10, wherein a back surface of the body and the mounting plate form a generally L-shaped bracket.

12. A striker bar assembly as defined in claim 9, wherein the body is formed from a molded polymer.

13. A striker bar assembly as defined in claim 9, wherein the handle is substantially semi-circular.

14. A striker bar assembly as defined in claim 9, wherein the aperture in the handle includes a contoured surface.

15. A striker bar assembly as defined in claim 9, wherein the striker bar receiving opening in the boss is an elongated opening extending through the entire length thereof.

16. A striker bar assembly as defined in claim 15, wherein the striker bar may be mounted to extend from either side of the elongated opening.

17. A striker bar assembly for use in cooperation with a latch mechanism comprising:
the striker bar assembly comprising a body mounted to a pivotably movable door, the body including a handle having an aperture and;
a striker bar having a mounting end which is inserted directly into a receiving opening positioned at a distal end of the body adjacent to the handle aperture to securely mount the striker bar to the body, the striker bar having a latch portion which extends outwardly from the movable door and to operatively cooperate with the latch mechanism to selectively maintain the gate in a closed position the body and wherein the striker bar does not contact the pivotably movable door.

18. A striker bar assembly as defined in claim 17, wherein the body includes a boss extending outwardly from a mounting surface of the body and wherein the receiving opening is formed in the boss.

19. A striker bar assembly as defined in claim 18, wherein the receiving opening is enclosed by and extends completely through the boss.
